(19) United States
(12) Patent Application Publication
(10) Pub. No.: US 2006/0018940 A1
(43) Pub. Date: Jan. 26, 2006

(54) Stabilized antimicrobial composition

(75) Inventors: David George DiPietro, Mullica Hill, NJ (US); Carl W. Erkenbrecher JR., Elkton, MD (US); Madhusudan D. Jayawant, Hockessin, DE (US); Colleen D. Merritt, Wilmington, DE (US); Allen H. Rau, Cincinnati, OH (US); Richard Alan Reynolds, Middletown, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(73) Assignee: E. I. DU PONT DE NEMOURS AND COMPANY

(21) Appl. No.: 11/117,625

(22) Filed: Apr. 28, 2005

Related U.S. Application Data
(60) Provisional application No. 60/589,661, filed on Jul. 21, 2004.

(51) Int. Cl. A01N 25/00; A01N 59/16; A01N 59/08

(52) U.S. Cl. 424/405; 424/641; 424/661

(57) ABSTRACT

A composition is disclosed comprising a dissolvable solid containing an active oxygen compound and precursors for chlorine dioxide characterized in that when said solid weighs a total of about 5 grams it dissolves in about 3.8 liters of water at 25° C. in less than 30 minutes, thereby generating an antimicrobial solution containing at least 10 ppm chlorine dioxide.

### FIELD OF THE INVENTION

This invention relates to the field of generating a mixture of chlorine dioxide and active oxygen from a stabilized composition for use as an antimicrobial deodorant and disinfectant.

### BACKGROUND OF THE INVENTION

Chlorine dioxide is used as a antimicrobial and/or deodorizing agent, but can be highly toxic when misapplied, and great care must be exercised to keep any human or animal exposure down to a safe limit. Chlorine dioxide is also unstable in solution and cannot be stored for any extended length of time. Alternatively, metal chlorite salts may be employed, using acidification to generate chlorine dioxide under controlled conditions.

Patent Application WO 03/055797 discloses a method for the production of chlorine dioxide mixed with oxygen by reacting a chlorite with peroxymonosulfate in an acidic aqueous solution in the presence of a redox initiator (such as a peroxodisulfate or oxalic acid). A chloride salt, preferably sodium chloride, and/or hydrogen sulfate may be added in order to accelerate the reaction at low temperatures. The application also discloses a kit for carrying out this reaction wherein one composition contains a chlorite and the second separate composition contains a peroxymonosulfate mixed with the redox initiator. In one embodiment, the two dry compositions may be in the form of two separate tablets. All examples show the introduction of the above two compositions separately into water having an elevated-temperature. This method of generating a mixture of chlorine dioxide and oxygen does not provide a single, easily dissolvable composition.

There is a need for a composition that upon dissolution in water generates in a short period of time an aqueous solution containing active oxygen and a safe concentration of chlorine dioxide suitable for deodorizing and disinfecting purposes. It is desired to have an alternative for specialized and costly chlorine dioxide generating equipment by providing a pre-measured, convenient dosage in an easy-to-use, safe to handle and store form, preferably tablet form, to deliver chlorine dioxide in solution at a consistently safe handling level, leaving behind no insoluble material. In addition, it is desired to eliminate the need to store quantities of sodium chlorite and acid for chlorine dioxide generation. The present invention provides such a composition.

### SUMMARY OF THE INVENTION

The present invention comprises a composition comprising an active oxygen compound and precursors for chlorine dioxide in the form of a solid, said solid when weighing a total of about 5 grams, dissolves in about 3.8 liters of water at 25° C. in less than 30 minutes, thereby generating a solution containing at least 10 ppm chlorine dioxide. Preferably the composition comprises, by weight:

a) from about 60% to about 90% of a sulfur-containing oxyacid,

b) from about 3% to about 25% of a soluble chlorite salt,

c) from about 3% to about 12% of an alkali metal halide salt or alkaline earth metal halide salt, provided that a cation of said alkali metal halide salt or alkaline earth metal halide salt does not form a sulfate with a solubility of less than 1% in 25° C. water, and

d) from about 2% to about 20% of an alkali metal carbonate, alkaline earth metal carbonate, alkali metal bicarbonate, or alkaline earth metal bicarbonate, provided that a cation of said alkali metal carbonate, alkaline earth metal carbonate, alkali metal bicarbonate, or alkaline earth metal bicarbonate does not form a sulfate with a solubility less than 1% in 25° C. water.

The present invention further comprises a method of deodorizing surfaces comprising application to the surface of a solution containing the dissolved composition described above.

The present invention further comprises a method of deodorizing, sanitizing and/or disinfecting surfaces comprising application to the surface of a solution containing the dissolved composition described above.

### DETAILED DESCRIPTION OF THE INVENTION

Trademarks are indicated herein by capitalization.

This invention relates to an easily dissolvable composition, preferably a tablet, for generating an aqueous solution of chlorine dioxide and active oxygen for use as a general purpose antimicrobial agent, sanitizing agent, disinfecting agent, bacteriocidal agent, fungicidal agent, and deodorant. The composition comprises an active oxygen compound and precursors for generating chlorine dioxide. The composition of this invention is characterized by having a sufficient hardness in tablet form to resist breakage during handling, and by the property that a tablet or other unit, when weighing about 5 grams, will dissolve in about 1 U.S. gallon (3.8 liters) of water at 25° C. in less than 30 minutes, preferable less than 15 minutes, thereby generating a solution containing at least 10 ppm of chlorine dioxide. Using an optimum composition and processing conditions, dissolution times of below 15 minutes are obtainable without stirring, creating chlorine dioxide solution concentrations above 15 ppm.

The composition is a solid and can be in any physical form. Examples include a powder, agglomerate, gel, tablet or other solid unit in any geometric shape. Preferred for use herein is a tablet, but other solid forms can be used for the composition.

The term “tablet” as used herein means a mass of solid material, usually compacted, compressed, molded, or extruded, of various physical forms such as a caplet, gelcap, briquette, disk, block or unit.

The term “microorganism” as used herein refers to any noncellular or unicellular (including colonial) organism. Microorganisms include all prokaryotes. Microorganisms include bacteria (including cyanobacteria and Mycobacteria), lichens, fungi, mold, protozoa, virinos, viroids, viruses, and some algae. As used herein, the term “microbe” is synonymous with microorganism.

The term “antimicrobial” as used herein means an agent which destroys or incapacitates microorganisms, as well as inhibits the growth of microorganisms.

The term “sanitizer” as used herein means an agent which provides antimicrobial activity. US EPA standards require a 5-log kill of bacteria in 30 seconds.

The term “disinfectant” as used herein means an agent which provides antimicrobial activity. US EPA Standards require a 3 log kill of particular pathogenic bacteria in 10 minutes. These bacteria are S. aureus, P. aeruginosa and S. choleraesuis.

The term “ppm” as used herein means micrograms per gram.

Preferably the composition of the present invention comprises, by weight percent, the following ingredients:

a) from about 60% to about 90% of a sulfur-containing oxyacid,

b) from about 3% to about 25% of a soluble chlorite salt,

c) from about 3% to about 12% of an alkali metal halide salt or alkaline earth metal halide salt, provided that a cation of said alkali metal halide salt or alkaline earth metal halide salt does not form a sulfate with a solubility less than 1% in 25° C. water, and

d) from about 2% to about 20% of an alkali metal carbonate or bicarbonate, or alkaline earth metal carbonate or bicarbonate, provided that a cation of said carbonates or bicarbonates does not form a sulfate with a solubility less than 1% in 25° C. water,

provided that the weight percentages of components add up to 100%.

Optionally, the composition of the present invention also contains, by weight:

e) 0 to about 15% of a water-soluble tablet binder, such as sugar alcohol, maltodextrin or corn syrup solids;

f) 0 to about 5% of a water-soluble starch or modified starch;

g) 0 to about 5% of a tablet lubricant, preferably water-soluble tablet lubricant;

h) 0 to about 5% of a punch face anti-adherent, preferably a water-soluble punch face adherent;

i) 0 to about 5% of a fragrance enhancer;

j) 0 to about 20% of an acid other than the oxyacid, and

k) 0 to about 32% of any suitable filler.

When optional components are included, the amounts are chosen so that the weight percent of the components total to 100%.

The major ingredient in the inventive composition is the sulfur-containing oxyacid (a). This both supplies the active oxygen and reacts with the soluble chlorite to generate chlorine dioxide. Suitable active oxygen compounds are those that provide a source of active oxygen, and may also provide a source of sanitizing or disinfecting action. Preferred are sulfur-containing oxyacids such as peroxysulfuric acids and their salts. Examples include peroxymonosulfuric acid and peroxydisulfuric acids and their salts. Preferably the sulfur-containing oxyacid contains an alkali monopersulfate and/or dipersulfate, more preferably potassium monopersulfate, and still more preferably contains the triple salt of potassium monopersulfate, potassium hydrogen sulfate and potassium sulfate. The latter is approximately represented by the formula 2KHSO₅.KHSO₄.K₂SO₄, and is available from the E. I. du Pont de Nemours and Company, Wilmington, Del., under the trade name of OXONE. It is present in the tablet in the amount of from about 60% to about 90% by weight, preferably from about 60% to about 80% by weight, and more preferably from about 70% to about 75% by weight.

The inventive composition also contains a soluble chlorite salt (b) which will react with the above oxyacid in water to generate chlorine dioxide. Preferably, it is a soluble chlorite salt. Examples of such soluble chlorite salts include alkali metal or alkaline earth salts. More preferably the soluble chlorite salt is sodium chlorite. It is present in the tablet in the amount of from about 3% to about 25% by weight, preferably from about 3% to about 10% by weight, and more preferably at about 5% by weight.

The inventive composition also contains an alkali metal halide salt or alkaline earth metal halide salt (c), with the proviso that its cation does not form a sulfate with a solubility less than 1% in 25° C. water. Preferably, the halide salt is selected from the group consisting of magnesium chloride and sodium chloride. Zinc chloride and zinc bromide are also suitable for use herein. More preferably, the soluble halide salt is magnesium chloride. The halide salt can act as a catalyst to speed up the generation of chlorine dioxide. When certain halide salts are used, such as magnesium chloride, they also provide a local heating effect due to their heat of solution, thus also promoting the tablet dissolution and chlorine dioxide generation. The halide salt is present in the tablet in the amount of from about 3% to about 12% by weight, preferably from about 5% to about 10% by weight, more preferably at about 8% by weight.

The inventive composition also contains an alkali metal carbonate, alkali metal bicarbonate, alkaline earth metal carbonate or alkaline earth metal bicarbonate (d), with the proviso that its cation does not form a sulfate with a solubility less than 1% in 25° C. water. Preferably, it is chosen from the list consisting of sodium bicarbonate, sodium carbonate, potassium bicarbonate, potassium carbonate, magnesium bicarbonate, and magnesium carbonate. More preferably, it is sodium bicarbonate. It is present in the amount of from about 2% to about 20% by weight, preferably from about 2% to about 10% by weight, more preferably at about 5% by weight of the tablet. In addition to its effect in adjusting solution pH, the carbonate or bicarbonates react in an aqueous acid medium to generate carbon dioxide and a resulting effervescence, thus further promoting dissolution of the tablet.

The inventive composition optionally contains 0 to about 15% of a water-soluble tablet binder (e), to increase the hardness of the tablet and also to increase the tablet solubility in water. Any available such binder may be used. A binder such as a sugar alcohol, maltodextrin or corn syrup solids is preferred. More preferably, the binder is a sugar alcohol. More preferably, the sugar alcohol is sorbitol. The tablet binder is preferably present in the amount of from about 1% to about 10% by weight, more preferably about 4%.

The inventive composition also optionally contains 0 to about 5% by weight of a water-soluble starch or modified starch (f). It is preferably present at from about 2% to about 3% by weight. Any available such starch may be used including starches derived from corn, wheat, soy, rice, potato, or cellulose. The starch provides an entry point for water and so aids dissolution in water.

The inventive composition also optionally contains 0 to about 5% by weight of a lubricant (g). Lubricant and compression aids ensure good release of the tablet from the tablet die and are well known in the art. Suitable lubricants include polyethylene glycol, sodium benzoate, stearates such as magnesium stearate, sucrose stearate, and the like, mineral oil, and silicone lubricants. Preferable is a water-soluble tablet lubricant such as polyethylene glycol in an amount of from about 1% to about 2% by weight. Preferably, it has a molecular weight of 3000 to 10000, more preferably 3000-9000, still more preferably about 7000 to 9000. Preferably the lubricant is polyethylene glycol 180 (PEG 180) available from Dow Chemicals, Midland, Mich. The lubricant acts on the sidewall of each unit cavity in the equipment used during the tableting process. This helps avoid maintenance problems with the tableting equipment and helps insure proper tablet release and tablet integrity.

The inventive composition also optionally contains 0 to about 5% of a punch face anti-adherent (h). Preferred is a water-soluble punch face anti-adherent such as sodium benzoate. This aids in the tableting process by providing a lubricant for the bottom of the unit cavity and the punch face in the tableting equipment. This helps avoid maintenance problems with the tableting equipment and helps insure proper tablet release and tablet integrity. Preferably the anti-adherent is present at 0 to about 1% by weight of the tablet.

The inventive composition also optionally contains 0 to about 5% of a fragrance enhancer (i). any available fragrance enhancer may be used, with the proviso that the fragrance is stable in the presence of oxidizing agents. Preferably the fragrance enhancer is present at 0 to about 0.5% by weight.

The inventive composition also optionally contains 0 to about 20% by weight of a co-acid (j), an acid other than the oxyacid, for the purpose of pH adjustment. Preferably, the solution pH is adjusted to 2.5 to 5.0 for optimum generation of ClO₂. Preferably, the co-acid is selected from the group of adipic acid, malic acid, sulfamic acid, citric acid, tartaric acid, glutaric acid, succinic acid, or sodium bisulfate.

The inventive composition also optionally contains from about 0 to about 32% of a filler. Any suitable filler can be used, for example, an alkali metal sulfate or alkaline earth metal sulfate. Potassium sulfate and sodium sulfate are examples of such filler.

The inventive composition is readily dissolvable in water at room temperature. The exact time it takes to dissolve in water may vary significantly. It depends on many factors besides the composition; for example, such factors as the physical form, size, number and shape, its surface and interior hardness, its surface roughness or glaze, its moisture content, the dissolving water temperature, the amount of water, the degree of stirring, and the like. In addition, some variation can be expected in the dissolution time due to the particle size of the individual components in the blend and the uniformity of the blend. The exact dissolution time for a particular composition will vary depending upon these factors. It is significant primarily for comparative purposes, i.e., to compare one composition with another composition, where the comparison tests are carried out using standardized mixing, tableting and dissolving procedures, and using a specific tableting apparatus.

Any methods known to one skilled in the art can be used to produce the composition of the invention, such as mixing, kneading, blending, pelleting, tableting, or extruding. The process for making the composition is carried out under any suitable means, such as ambient temperature and pressure using conventional equipment. For example, tableting can be employed to produce tablets that will dissolve readily in water, yet have sufficient hardness to reduce breakage during packaging and handling. If desired, even faster dissolution times can be obtained by using water at a somewhat elevated temperature, using care to avoid too rapid reaction rates.

For example, tablets are prepared using conventional tableting processes and equipment. The ingredients are weighed, and can be sieved to reduce the size of any agglomerates. The components are physically combined and mixed, for example using a Hobart mixer. The fragrance, if present, is typically premixed with one of the other solid components to reduce loss and ease blending. The components are mixed and the blend is fed into a tablet press, for example a Stokes DD2 rotary press available from DT Converting Technologies, 400 Kidd's Hill Road, Hyannis, Mass. 02601. The press is adjusted to deliver tablets of the desired size and hardness, and the tablets pressed.

The present invention further comprises a method of deodorizing and/or sanitizing and/or disinfecting surfaces comprising application to the surface of an aqueous solution of the composition of the present invention. This method is also useful for providing an antimicrobial or fungicidal effect. This method is useful in providing a solid composition that upon dissolution in water generates in a short period of time an aqueous solution containing active oxygen and a safe concentration of chlorine dioxide suitable for deodorizing and sanitizing fibrous substrates and hard surfaces. Fibrous substrates include carpet, textiles, upholstery, drapery, and other household materials. Suitable materials include those of natural and synthetic fibers. The aqueous solution containing the dissolved composition is applied to a fibrous substrate, such as a textile or carpet, by conventional means such as spraying, foaming, padding, and similar techniques. Hard surfaces suitable for treatment with the present invention include porous concrete, brick, tile, stone, grout, mortar, terrazzo, gypsum board, wood, metal, laminated materials such as FORMICA, vinyl, porcelain, granite, or composite materials typically found in household use for countertops, shelving, flooring, and other household surfaces. The aqueous solution containing the dissolved composition is applied to a substrate having a hard surface by conventional means such as spraying, foaming, pouring, sponging and similar techniques.

The inventive composition provides for the efficient conversion of sodium chlorite to chlorine dioxide, and has the advantage that all ingredients are water-soluble, so that no insoluble residue is left behind on the sanitized surface. Any residual, unconverted sodium chlorite left on the surface will have residual biocidal and deodorizing effects.

The aqueous solution of the composition of the present invention is effective as an antimicrobial agent. It inhibits the growth of microorganisms, and also acts as a lethal agent to destroy and/or incapacitate microbial cells. In particular, the aqueous solution of the composition of the present invention is effective as a bacteriocide and fungicide. Thus, such solutions are useful and effective as sanitizing agents, disinfecting agents, and deodorizing agents for various surfaces as described above. Reduction of the population of microorganisms on treated surfaces is of benefit in providing protection to those in contact with such surfaces.

The procedures used in the following examples are intended to be illustrative of the invention, but are not intended to limit the scope of this invention in any way, which is to be limited only by the attached claims.

Analyses

In all the following examples, the ppm ClO₂ concentrations and active oxygen were determined as follows. The tablet was first dissolved in 3.8 L of deionized water. The ppm ClO₂ concentrations were measured using a Hach DR/890 Series Colorimeter and the Hach Method 8345, available from The Hach Company, P.O. Box 389, Loveland, Colo. 80539. To determine the ppm of Active Oxygen due to ClO₂, abbreviated as “ppm AO (ClO₂)”, the above result is multiplied by 0.593.

The ppm of Active Oxygen due to the sulfur-containing oxyacid (OXONE), abbreviated as “ppm AO (OXONE)”, was determined as follows. First, the total active oxygen content of the above solution was determined. The tablet was dissolved in 3.8 L of deionized water. To a 50 g sample of the solution, 10 mL of 20% sulfuric acid and 10 mL of 25% potassium iodide were added. The solution was then titrated with sodium thiosulfate as disclosed in the DuPont technical bulletin for OXONE, available from E. I. du Pont de Nemours and Company, Barley Mill Plaza 23, 4417 Lancaster Pike, Wilmington, Del. 19805, and on the Internet at “http://www.dupont.com/oxone/techinfo/”. This value was then corrected by deducting the ppm AO (ClO₂) as determined above, to determine the ppm AO (OXONE).

### EXAMPLES 1-5

Tablets were produced as follows: Individual ingredients were weighed out on an analytical balance. The sodium chlorite was pre-milled with a mortar and pestle to reduce particle size and lumps. The fragrance was premixed with an individual component, usually the sodium benzoate, to ease its uniform transfer into the mix. All materials were then manually combined and mixed in a jar for five minutes or until a uniform mixture was obtained. The mixed material was then pressed into tablets using a Carver lab press available from Carver at 1569 Morris St., Wabash, Ind. 46992. Pressure applied to the die was 10,000 psi (69.0×10⁶ Pa). Single tablets weighing 5.75 grams or 10 grams were produced in this way having the formulations listed in Table 1. B656 starch denotes INSCOSITY B656 cornstarch available from Grain Processing Corporation, Mascatine, Iowa. A solution was prepared by dissolving the tablet in 3.8 L of deionized water and dissolution time was measured. The solution was tested for chlorine dioxide and active oxygen using the methods described above, as well as for pH and dissolution time. The results are displayed in Table 1.

TABLE 1

| | Example | | | | |
|---|---|---|---|---|---|
| | 1 | 2 | 3 | 4 | 5 |
| OXONE, g | 77.3 | 77.4 | 73.9 | 75.2 | 72.6 |
| Magnesium | 9.1 | 4.5 | 8.7 | 7.1 | 8 |
| chloride, g | | | | | |
| Sorbitol, g | 0 | 4.5 | 4.4 | 4.4 | 4 |
| Sodium chlorite, g | 4.5 | 4.5 | 4.4 | 4.4 | 5 |
| Sodium bicarbonate, | 2.7 | 2.7 | 2.6 | 3.1 | 5 |
| g | | | | | |
| B656 starch, g | 3.2 | 3.2 | 3 | 2.7 | 2.6 |
| Polyethylene glycol- | 1.8 | 1.8 | 1.7 | 1.8 | 1.5 |
| 180, g | | | | | |
| Sodium benzoate, g | .9 | .9 | .9 | .9 | .9 |
| Fragrance, g | 0.5 | 0.5 | 0.4 | 0.4 | 0.4 |
| Total formula wt., g | 100 | 100 | 100 | 100 | 100 |
| Tablet Weight g | 5.75 | 5.75 | 5.75 | 5.75 | 10.0 |
| ppm ClO₂ | | | | | |
| (in 3.8 L. water) | 29.2 | 17.2 | 30.1 | 24.1 | 48 |
| Recheck ppm ClO₂ | | | 32.7 | 28.8 | na |
| PH | 3.18 | 3.7 | 3.25 | na | na |
| ppm OXONE | 865 | 1088 | 961 | na | na |
| ppm AO (OXONE) | 42 | 52 | 46 | na | na |
| ppm AO (ClO₂) | 18 | 10 | 18 | na | na |
| Temp. ° C. | 24 | 26 | 26 | 24 | 24 |
| Time to Dissolve | 4:22 | 2:20 | 5+ | 5 (half | 5 |
| (Min.:Sec.) | | | | dissolved) | |
| Comment: | | | with light | test | |
| | | | stirring | discontinued | |

Table 1 documents formulations having a ClO₂ level of greater than 17 ppm with dissolution times generally less than 10 minutes. The ClO₂ generation approximately doubled with the 10 gram tablet compared to the 5.75 gram tablet.

### EXAMPLES 6 TO 9

Sample tablets containing as primary ingredients OXONE, sodium chlorite, magnesium chloride, and sodium bicarbonate in the amounts listed in Table 2 were produced. Smaller amounts of a sugar alcohol, starch, polyethylene glycol, sodium benzoate and a fragrance as listed in Table 2 were used to aid dissolving or tableting or to provide aesthetics. Individual batches were produced in various sizes approximately 8 Kg in weight.

The ingredients were weighed out using a large, floor scale. The components were then mixed with an industrial-sized “kitchen style” Hobart mixer with a paddle. The blended powder was fed into a Stokes DD2 rotary press. Tablets of about 2 grams each were produced. The tablet “hardness” was quantified by measuring the pressure required to crush the tablets. Results were measured using a kiloponds scale from 1 to about 12, with a hardness of about 5 indicating a minimum hardness for commercial packaging purposes. The tablets were analyzed for chlorine dioxide and active oxygen as previously described, as well as for dissolution time and pH. The effect on dissolution time of varying tablet size while maintaining ClO₂ levels was observed. Smaller 2-2.5 gram tablets were tested two at a time to produce results comparable with the single 5.75-gram tablets in Table 1. The resulting data are listed in Table 2.

TABLE 2

| | Example | | | |
|---|---|---|---|---|
| | 6 | 7 | 8 | 9 |
| OXONE, g | 73.9 | 72.6 | 72.6 | 72.6 |
| Magnesium chloride, g | 8.7 | 8 | 8 | 8 |
| Sorbitol, g | 4.3 | 4 | 4 | 4 |
| Sodium chlorite, g | 4.3 | 5 | 5 | 5 |
| Sodium bicarbonate, g | 3 | 5 | 5 | 5 |
| B656 starch, g | 2.6 | 2.6 | 2.6 | 2.6 |
| PEG-180, g | 1.8 | 1.5 | 1.5 | 1.5 |
| Sodium benzoate, g | .9 | 0.9 | 0.9 | 0.9 |
| Fragrance, g | 0.5 | 0.4 | 0.4 | 0.4 |
| Total formula wt., g | 100 | 100 | 100 | 100 |
| Tablet Weight, g | 2.0 | 2.1 | 2.1 | 2.1 |
| Hardness | 5 | 11 | 6.5 | 5 |
| ppm ClO₂ | 15.5 ppm-5 min | 11.5 ppm-5 min | 14.2 ppm-5 min | 27 ppm-5 min |
| (in 3.8 L. water) | 20.6 ppm-10 min | na | 15.2 ppm-7 min | 26 ppm-7 min |
| PH | na | na | na | 4.4 |
| ppm OXONE | na | na | na | 766 |
| ppm AO (OXONE) | na | na | na | 37 |
| ppm AO (ClO₂) | na | na | na | 16 |
| Temp. ° C. | na | na | na | 26 |
| Time to Dissolve | 5 min | 5 min | 5+ min | 5 min |
| (Mill.: Sec.) | | | | |
| Comment: | Complete | Complete | Complete | Complete |
| | Dissolution | Dissolution | Dissolution | Dissolution |

Note:
na means not available.

The data in Table 2 demonstrated that the best balance was found at a hardness test reading of about 5 which gave a tablet with a ClO₂ level in the mid-20 ppm range and dissolution time of about 5 minutes.

### EXAMPLE 10

A 50-gram batch of the composition of Example 9 was prepared using half the amounts of components as listed in Table 2 and using a specific protocol which required keeping the chemicals dry and in a low humidity environment. The sodium chlorite was ground with a mortar and pestle prior to being mixed with the OXONE. Then the sodium bicarbonate, magnesium chloride, sorbitol, sodium benzoate, PEG-180, and a starch-fragrance blend were added in that order. The 50 gram batch was then mixed in a glass jar and mixed thoroughly on a roller mill for 20 minutes to assure uniformity of the blend. Die size necessitated that five grams of the above blend were weighed, divided into three parts and pressed into three tablets on a Carver press. The total weight of the three tablets was five grams. The three tablets were placed in 3780 grams of distilled water and allowed to dissolve without stirring. Dissolution time, pH, temperature and ppm of ClO₂ were measured. The ppm of ClO₂ was measured using a Hach DR890 colorimeter as previously described. Results are shown in the Table 3.

TABLE 3

| Example | | Dissolution | Tablet Wt | | ClO₂ |
|---|---|---|---|---|---|
| No. | pH | time (min.) | (Grams) | Temp. ° C. | (ppm) |
| 10A | 4.039 | 9:52 | 5.04 | 26.8 | 15.1 |
| 10B | 4.128 | 8:49 | 5.03 | 26.6 | 14.9 |
| 10C | 4.104 | 9:19 | 5.04 | 27.1 | 15.2 |
| 10D | 4.186 | 8:58 | 5.04 | 27.2 | 15.5 |
| 10E | 4.142 | 9:26 | 5.06 | 26.8 | 15.2 |

The above tests showed that the ClO₂ measurements were very consistent and that the pH and dissolution time was very similar for each of the tablets tested.

### EXAMPLE 11

Tablets were produced using the composition of Example 9 as listed in Table 2, using commercial scale equipment. A 10-kg batch was made using the following procedure: The ingredients were weighed out using a large, floor scale. The sodium chlorite was pre-milled to reduce particle size, and the fragrance was mixed with the sorbitol to ease transfer, and an overall 10-kg mixture was blended using a “kitchen style” Hobart mixer with a paddle for 10 minutes. The blended powder was fed into a Stokes DD2 rotary press. The tablet “hardness” was 5 indicating a minimum hardness for commercial packaging purposes. The tablets were sized for an approximate weight of 2.6 grams per tablet. When tested by dissolving in 26° C. water, the tablet dissolution time was under 5 minutes. The tablets were tested for stability with the results shown in Table 4:

TABLE 4

| Measurement | Initial Test | Tested 5 weeks later |
|---|---|---|
| ppm ClO₂ | 27.0 | 27.3 |
| ppm OXONE | 766 | 860 |
| ppm AO (OXONE) | 37 | 41 |
| ppm AO (ClO₂) | 16 | 16 |

The tablet performance and stability were both satisfactory.

### EXAMPLE 12

The purpose of these experiments was to determine the effect on performance of tablets by varying the Carver Press pressure during tableting. A series of tablets was made using the composition of Example 9 as listed in Table 2. A 14-mm die was used, giving a tablet approximately ⅜ inch thick. Dissolution testing was done using 3 tablets weighing a total of 5 grams. The tablets were dissolved in one gallon of water and tested as previously described.

TABLE 5
Effect of Tableting Pressure

| | 1250 | 2500 | 5000 | 10000 | 20000 I |
|---|---|---|---|---|---|
| | (8.6 × | (17.2 × | (34.5 × | (69.0 × | (137.9 × |
| Carver Pressure, psi | 10⁶ Pa) | 10⁶ Pa) | 10⁶ Pa) | 10⁶ Pa) | 10⁶ Pa) |
| Weight of Tablets, gm | 4.97 | 5 | 5.01 | 5.01 | 5.00 |
| PH | 3.7 | 3.7 | 3.8 | 4.5 | 4.5 |
| Ppm ClO₂ | 23.6 | 23.5 | 23.7 | 25.5 | 26 |
| Ppm AO(OXONE) | 40 | 36 | 36 | 41 | 40 |
| Ppm AO (ClO₂) | 14 | 14 | 14 | 15 | 15 |
| Temp. ° C. | 27 | 26 | 27.5 | 25 | 25 |
| Time to Dissolve | 9 | 16 | 16 | 18 | 20 |
| (Min.) | | | | | |

The above tests showed that the chemical performance of the tablets was very constant regardless of tableting pressure, and that the only noticeable effect was on dissolution time, particularly at the lower end of the pressure scale.

### EXAMPLES 13 TO 17 AND COMPARATIVE EXAMPLES A TO D

A series of tablets were produced using the procedure and composition of Example 8 except that equal amounts of various chemicals were substituted for the magnesium chloride. The purpose of these tests was to find if any other chemicals showed the beneficial effect of magnesium chloride in speeding up the tablet dissolution and generation of ClO₂. Some of the chemicals tested were chosen because they were known to generate heat on dissolving in water, while others were chosen to see the utility of other halide salts for speeding the ClO₂ generation. Results are shown in Table 6 below.

TABLE 6

| | Magnesium | Water | Dissloution | | ClO₂ ppm | ClO₂ ppm | ClO₂ | |
|---|---|---|---|---|---|---|---|---|
| Ex. | chloride or | Temp. | Time | | test 1 | test 2 | AO | OXONE |
| No. | replacement | ° C. | (min.) | pH | (Note 1) | (Note 1) | ppm | ppm |
| 13 | Magnesium | 25 | 8 | 4.5 | 11.8 | 12.9 | 7 | 47 |
| | chloride | | | | | | | |
| A | Calcium oxide | 25 | 60 | 3.4 | 2.1 | 3.4 | 1 | — |
| | | | (Note 2) | | | | | |
| B | Calcium | 26 | 60 | not | 13.8 | 13.9 | 8 | — |
| | chloride (two | — | 60+ | meas. | 16.6 | — | 10 | — |
| | trials) | | | | | | | |
| C | Calcium | 24 | 20 (with | 3.7 | 11.3 | 11.6 | 7 | 44 |
| | bromide | | stirring) | | | | | |
| | | 27 | 60+ | 3.5 | 4.3 | — | 3 | 42 |
| 14 | Zinc chloride | 25 | 24 | 3.6 | 17.6 | 18.3 | 10 | 47 |
| | (two trials) | 26 | 20 | 3.8 | 14 | 19 | 8 | 48 |
| 15 | Zinc bromide | 27 | 25 (both | 4.1 | 21.1 | 21.7 | 13 | 39 |
| | (two trials) | 27 | 30 with | 4.2 | 19.2 | — | 11 | 37 |
| | | | stirring | | | | | |
| D | Sodium | 27 | 15 | 6.1 | 7.3 | — | 4 | 50 |
| | phosphate | 25 | 14 | 5.9 | 7.5 | — | 4 | 48 |
| | (two trials) | | | | | | | |
| 16 | Ferric chloride | 25 | 12 | 3 | 42.9 | — | 25 | 32 |
| | | | | | (Note 3) | — | | |
| 17 | Sodium | 26 | 10 | 5.3 | 11.8 | 12.8 | 7 | 50 |
| | chloride | | | | | | | |

Note 1. The time that the ClO₂ testing was carried out depended on the rate of tablet dissolution and varied accordingly.
Note 2. If the tablet was not completely dissolved at the end of 60 minutes, the experiment was halted.
Note 3. Ferric chloride testing was discontinued due to the yellow color which apparently interfered with the ClO₂ test. The calcium bromide also gave an orange color which may have interfered with results.

Only the halide salts gave ClO₂ generation rates above 10 ppm. While the exothermic properties that certain non-halide salts exhibited upon dissolution may have been helpful, there was no clear-cut relationship between the amount of heat generated and dissolution rate or ClO₂ concentration.

In terms of rapid tablet dissolution, the magnesium chloride composition was clearly superior to the other halide salts tested. The zinc chloride and zinc bromide compositions were also generally satisfactory in balancing all measured properties. The calcium chloride composition was satisfactory in ClO₂ generation, but appeared poor in solubility in the above test, possibly due to calcium sulfate formation by reaction with the OXONE.

### EXAMPLES 18 TO 19 AND COMPARATIVE EXAMPLE E

Test tablets were produced using the composition of Example 8 except that potassium or sodium persulfate was substituted for the OXONE. Ingredients were weighed on an analytical balance. The potassium or sodium persulfate and sodium chlorite were reduced in particle size with mortar and pestle and then ground together in like manner with the other ingredients. The mixture was placed in a jar and mixed on a roller mill for 20 minutes. Five grams of the mixture was made into 3 tablets of approximately the same size using a Carver lab press. The tablets were placed in a gallon (3.75 L) of water and allowed to dissolve. Measurements were then made to determine the ability to generate chlorine dioxide using the substituted ingredient.

TABLE 7

| | Example 18 | Example E | Example 19 |
|---|---|---|---|
| | OXONE | Potassium Persulfate | Sodium Persulfate |
| Water Temp | 26 C. | 27 C. | 24 C. |
| pH | 4.4 | 6.8 | 6.8 |
| Tablet Weight | 5 | 5.02 | 4.96 |
| Dissolution Time | 5 minutes | 60 minutes | 30 minutes |
| ppm ClO₂ | 27 | 11 | 16 |
| ppm OXONE | 766 | Na | Na |
| ppm AO | 37 | Na | Na |
| OXONE | | | |
| ppm AO ClO2 | 16 | 6.5 | 9.5 |

Na = not available

Both substitutions, sodium persulfate and potassium persulfate, generated ClO₂ in solution at acceptable and usable levels. However, potassium persulfate had an unacceptable dissolution time. Neither sodium nor potassium persulfate demonstrated the short dissolution time of the OXONE.

### EXAMPLE 20

Tablets were prepared as described above having the formulation of Example 6. A solution was prepared by dissolving two tablets in 2 gallons (3.5 L.) of deionized water and tested for microbial efficacy.

Inoculum Prep: Test bacteria included Staphylococcus aureus ATCC 6538, Pseudomonas aeruginosa ATCC 15442, and Salmonella choleraesuis ATCC 10708. Modified AOAC protocol 965.13 was used in which each culture was transferred daily for three days on TRYPTICASE Soy Agar (TSA). A suspension was made of each bacterium by adding 5 mL of sterile Butterfield buffer (BB) to the TSA plate and suspending the colonies using a sterile L-shaped inoculating rod. This was removed to a sterile Nephalo flask. Another 5 mL of BB was added to the plate, the plate swirled and resulting suspension added to the same Nephalo flask. A Klett reading was taken and the suspension further diluted with BB to give a Klett reading of about 24-29 (˜89% T; this is equivalent to ˜1.OE+08 CFU/mL). Stock inocula were further diluted 1:100 to provide densities as shown in Table 8.

Test System: A 0.1 mL aliquot of test inoculum was added to 9.9 mL of test substance, the tube mixed and a timer started. After the 10-min exposure time, a serial-dilution plate count was done on TSA. D/E (Dey/Engley) Neutralizing Broth (available from Becton Dickinson, Billerica, Mass.) was used for neutralization in the first serial-dilution tube. An inoculum control was also run by adding 0.1 mL of the test inoculum to 9.9 mL of BB and plated on TSA after the 10-min exposure time. All plates were incubated @ 35C for 18-24 h, colonies counted and densities calculated. To verify neutralization, one colony from a 24-h TSA plate was added to a 9.9 mL BB tube and from this tube a 1 uL loopful was inoculated into each Dey/Engley tube exhibiting no growth. A 0.1 mL aliquot was plated on TSA, incubated at 35° C. for 48 h and colonies counted. The 0.1 mL aliquot plated onto TSA plate resulted in approximately 200 colonies per plate. This was done for each test bacterium.

A chlorine dioxide control solution was prepared in filter-sterilized Millipore® water using Anthium Dioxide (stabilized sodium chlorite available from IDI, North Kingston, R.I.) acidified with concentrated HCl. ClO₂ concentrations of the prepared solution were measured using a 0-50 ppm Hach kit. Triplicate measurements were made: (1) 23.2 mg/L, (2) 23.0 mg/L, and (3) 23.5 mg/L and the average C10₂ concentration was 23.2 ppm.

TABLE 8

| | Plate Counts @ | Stock Inoculum |
|---|---|---|
| | Dilution | Density |
| S. aureus | 102/108@ −5 | 1.1E+08 |
| | | CFU/mL |
| P. aeruginosa | 39/44@ −5 | 4.2E+07 |
| | | CFU/mL |
| S. choleraesuis | 144/154@ −5 | 1.5E+08 |
| | | CFU/mL |

The density of bacteria challenged and the bacterial efficacy results are shown below in Tables 9A, 9B and 9C for each bacterium. In Tables 8, 9A, 9B and 9C, the notation of E plus or minus two digits means an exponent for which the two digits indicate the power of 10 by which the number preceding the E is multiplied. For example, 1.1 E+08 is 1.1×10⁸.

TABLE 9A

| Exposure | | Plate Count | | | Dilution | | |
|---|---|---|---|---|---|---|---|
| Time | Description | Rep A | Rep B | Mean | Factor | CFU/mL* | Δt |
| NA | Uninoculated Control | 0 | 0 | 0 | 1 | 0.00E+00 | NA |
| 30 sec | Inoculum: S. aureus | 90 | 181 | 136 | 0.001 | 1.36E+06 | NA |
| 30 sec | Example 20 = 1,008 ppm | 0 | 0 | 0 | 1 | 1.00E+01 | 5.1 |
| | Oxone + 55.5 ppm | | | | | | |
| | Chlorite | | | | | | |
| 30 sec | 1,008 ppm Oxone | 145 | 159 | 152 | 0.001 | 1.52E+06 | 0.0 |
| | control | | | | | | |
| 30 sec | 55.5 ppm Chlorite | 109 | 136 | 123 | 0.001 | 1.23E+06 | 0.0 |
| | control | | | | | | |
| 30 sec | 23.2 ppm ClO2 control | 0 | 0 | 0 | 1 | 1.00E+01 | 5.1 |
| 10 min | Inoculum: S. aureus | 157 | 164 | 161 | 0.001 | 1.61E+06 | NA |
| 10 min | Example 20 = 1,008 ppm | 0 | 0 | 0 | 1 | 1.00E+01 | 5.2 |
| | Oxone + 55.5 ppm | | | | | | |
| | Chlorite | | | | | | |
| 10 min | 1,008 ppm Oxone | 60 | 63 | 62 | 0.001 | 6.15E+05 | 0.4 |
| | control | | | | | | |
| 10 min | 55.5 ppm Chlorite | 113 | 126 | 120 | 0.001 | 1.20E+06 | 0.1 |
| | control | | | | | | |
| 10 min | 23.2 ppm ClO2 control | 0 | 0 | 0 | 1 | 1.00E+01 | 5.2 |
| 10 min | Inoculum: S. aureus - | 135 | 162 | 149 | 0.001 | 1.49E+06 | NA |
| | pH 4.5 Buffer | | | | | | |

*low level of detection is 1.0E+01 CFU/mL (CFU = colony forming units)
Δt is log difference test and control densities
NA = not applicable

TABLE 9B

| Exposure | | Plate Count | | | Dilution | | |
|---|---|---|---|---|---|---|---|
| Time | Description | Rep A | Rep B | Mean | Factor | CFU/mL* | Δt |
| NA | Uninoculated Control | 0 | 0 | 0 | 1 | 0.00E+00 | NA |
| 30 sec | Inoculum: P. aeruginosa | 95 | 108 | 102 | 0.001 | 1.02E+06 | NA |
| 30 sec | Example 20 = 1,008 ppm | 0 | 0 | 0 | 1 | 1.00E+01 | 5.0 |
| | Oxone + 55.5 ppm | | | | | | |
| | Chlorite | | | | | | |
| 30 sec | 1,008 ppm Oxone control | 71 | 119 | 95 | 0.001 | 9.50E+05 | 0.0 |
| 30 sec | 55.5 ppm Chlorite control | 104 | 129 | 117 | 0.001 | 1.17E+06 | −0.1 |
| 30 sec | 23.2 ppm ClO2 control | 0 | 0 | 0 | 1 | 1.00E+01 | 5.0 |
| 10 min | Inoculum: P. aeruginosa | 127 | 128 | 128 | 0.001 | 1.28E+06 | NA |
| 10 min | Example 20 = 1,008 ppm | 0 | 0 | 0 | 1 | 1.00E+01 | 5.1 |
| | Oxone + 55.5 ppm | | | | | | |
| | Chlorite | | | | | | |
| 10 min | 1,008 ppm Oxone control | 0 | 0 | 0 | 1 | 1.00E+01 | 5.1 |
| 10 min | 55.5 ppm Chlorite control | 105 | 136 | 121 | 0.001 | 1.21E+06 | 0.0 |
| 10 min | 23.2 ppm ClO2 control | 0 | 0 | 0 | 1 | 1.00E+01 | 5.1 |
| 10 min | Inoculum: P. aeruginosa - | 114 | 118 | 116 | 0.001 | 1.16E+06 | NA |
| | pH 4.5 Buffer | | | | | | |

*low level of detection is 1.0E+01 CFU/mL (CFU = colony forming units)
Δt is log difference test and control densities
NA = not applicable

TABLE 9C

| Exposure | | Plate Count | | | Dilution | | |
|---|---|---|---|---|---|---|---|
| Time | Description | Rep A | Rep B | Mean | Factor | CFU/mL* | Δt |
| NA | Uninoculated Control | 0 | 0 | 0 | 1 | 0.00E+00 | NA |
| 30 sec | Inoculum: S. choleraesuis | 137 | 144 | 140.5 | 0.001 | 1.41E+06 | NA |
| 30 sec | Example 20 = 1,008 ppm | 0 | 0 | 0 | 1 | 1.00E+01 | 5.1 |
| | Oxone + 55.5 ppm | | | | | | |
| | Chlorite | | | | | | |
| 30 sec | 1,008 ppm Oxone | 209 | 218 | 213.5 | 0.001 | 2.14E+06 | −0.2 |
| | control | | | | | | |
| 30 sec | 55.5 ppm Chlorite | 306 | 312 | 309 | 0.001 | 3.09E+06 | −0.3 |
| | control | | | | | | |
| 30 sec | 23.2 ppm ClO2 control | 0 | 0 | 0 | 1 | 1.00E+01 | 5.1 |
| 10 min | Inoculum: S. choleraesuis | 200 | 241 | 220.5 | 0.001 | 2.21E+06 | NA |
| 10 min | Example 20 = 1,008 ppm | 0 | 0 | 0 | 1 | 1.00E+01 | 5.3 |
| | Oxone + 55.5 ppm | | | | | | |
| | Chlorite | | | | | | |
| 10 min | 1,008 ppm Oxone | 29 | 30 | 29.5 | 0.1 | 2.95E+03 | 2.9 |
| | control | | | | | | |
| 10 min | 55.5 ppm Chlorite | 115 | 138 | 126.5 | 0.001 | 1.27E+06 | 0.2 |
| | control | | | | | | |
| 10 min | 23.2 ppm ClO2 control | 0 | 0 | 0 | 1 | 1.00E+01 | 5.3 |
| 10 min | Inoculum: S. choleraesuis - | 199 | 209 | 204 | 0.001 | 2.04E+06 | NA |
| | pH 4.5 Buffer | | | | | | |

*low level of detection is 1.0E+01 CFU/mL (CFU = colony forming units)
Δt is log difference test and control densities
NA = not applicable

The tablet of the invention dissolved in 2 gal. (7.6L) of water was very effective in killing all three bacteria with a ≧5-log reduction in 30 sec. For S. aureus, this level of activity was probably attributed to the generation of ClO₂ (23.2 ppm) in solution because the ClO₂ control also demonstrated the same level of kill in 30 sec (see Table 9A). Similarly for P. aeruginosa, the 5-log kill was probably attributed to the generation of ClO₂ in the 30-sec exposure even though efficacy from OXONE alone at 1,008 ppm was also demonstrated at the 10-min exposure (see Table 9B). The ClO₂ control at 30 sec demonstrated complete kill (i.e., 5-log reduction). OXONE at 10 min, on the other hand, also demonstrated complete kill (i.e., 5.1-log reduction). For S. choleraesuis, this level of activity was also probably attributed to the generation of ClO₂ in the 30-sec exposure which demonstrated complete kill (i.e., 5.1-log reduction). Some efficacy (i.e., 2.9-log kill) from OXONE alone at 1,008 ppm was demonstrated at the 10-min exposure (see Table 9C).

### EXAMPLE 21

This assay had several modifications from the published AOAC Fungicidal Activity of Disinfectants Protocol, Method 955.17. Aspergillus fumigatus ATCC 1098 was grown on Malt Extract Agar (available from Becton Dickinson, Billerica, Mass.) plates, and spores were harvested. Spores were stored in filter-sterilized Millipore water at −20° C. The spore preparation used for this experiment is detailed below. A freezer stock of A. fumigatus was defrosted and diluted to obtain an inoculum suspension for this experiment. The inoculum preparation was estimated to be approximately 5×10⁶ conidia/mL. The following test solutions were prepared using filter sterilized Millipore water in steam-sterilized 4L bottles:

Water Control: (filter-sterilized water only), pH 6.28.

OXONE Control: 3.78 grams OXONE in 1 gallon (3.8L) sterile water, buffered to pH 4.43 using 0.98 g sodium bicarbonate and +5.25 g 10% H₂SO₄).

Chlorite Control: 0.26 grams of sodium chlorite in 1 gallon sterile water buffered to pH 4.55 (1.8 g 10% H₂SO₄).

Buffer Control: sodium bicarbonate, pH adjusted to 4.4.

Chlorine Dioxide: anthium dioxide (stabilized sodium chlorite available from IDI, North Kingston, R.I.) was acidified with HCl.

CLOROX control: 4.17% CLOROX bleach available from Clorox Company, Oakland, Calif. (v/v) in Millipore water by mixing 4.17 mL of Clorox bleach and water up to 100 mL total volume.

Tablet test Solution (Example 21: 2 tablets of Example 6 were dissolved in one gallon (3.8 L) of deionized water. The total tablet weight was 5.13 grams. The pH of the resulting solution was 5.2.

Reaction tubes: 5 mL of each test solution was aliquoted into 25×150 mm test culture tubes, capped and labeled according to Table 10. 9 mL of D/E (Dey/Engley) Neutralizing Broth (available from Becton Dickinson, Billerica, Mass.) was added to each of 28 test tubes and the tubes were capped. Butterfield buffer blanks were arranged for dilution of neutralized samples, and Malt Extract Agar plates were numbered for spore enumerations of the diluted, neutralized samples. With a graduated pipette, 0.5 mL of spore inoculum (approx. 10⁶ condia/mL) was added to the first tube of test solution and gently shaken. After 5 and 15 minute exposures to the respective test solutions, samples were gently shaken and 1 mL samples were removed from each reaction mixture (spore-test solution) using an Eppendorf pipette and placed in 9 mL D/E (Dey/Engley) Neutralizing Broth. The inoculum was further diluted to approximately 10⁴ condia/mL. Two more reaction tubes (water and OXONE-chlorite) and four Dey/Engley neutralization tubes were prepared to evaluate the efficacy of the tablet solution versus a final inoculum density of 10³ condia/mL in the reaction tube. Samples were reacted for 15 minutes only. Dilutions of neutralized samples were prepared. Two 100 μL aliquots of all samples in D/E (Dey/Engley) Neutralizing Broth were plated on Malt Extract Agar and incubated at 250C until the appearance of colonies. Plates were counted after colonies appeared, roughly 4 days after incubation. Several dilutions of the inoculum spore suspensions were also plated on Malt Extract Agar to obtain an accurate count of viable spores used as inoculum. The samples were incubated at 25° C. and counted after the appearance of colonies, after about 4 days of incubation.

A. fumigatus spores were inoculated into the controls and test solutions to a final density of ˜5.6-6.25×10⁵ conidia/mL, confirmed by the water and buffer controls. The inoculum solution was also plated, counted, and multiplied the volume (0.5 mL) added to the controls and test solutions to estimate density; 2.57×10⁵ conidia/mL inoculum density corresponded well with the water and buffer controls. Buffer control data was taken after 15 minutes. CLOROX control data was taken after 5 minutes of treatment.

Results indicated that the tablets of the invention (Example 21), Chlorine dioxide (˜23 ppm), and 4.17% CLOROX solution were capable of killing 5 log A. fumigatus spores within 5 minutes; chlorine dioxide and CLOROX were controls. Separately, OXONE control and chlorite control were not able to reduce the bioburden within 15 minutes of treatment.

Efficacy is affected by the bioburden density and organic soils. A lower density inoculum was prepared—6.7×10³ conidia/mL—and challenged with the tablet test solution (2 tabs/gallon) for 15 min. This test was performed in the event that the higher inoculum density (10⁵ conidia/mL) was not affected by the treatment. The tablet test solution of Example 21 treatment killed this lower inoculum as well.

A solution of the tablets of the present invention (Example 21) were capable of completely killing all A. fumigatus spores (5-6×10⁵ conidia/mL) within 5 minutes. Controls indicated that OXONE solution and sodium chlorite solution, equivalent to amounts found in the tablet solution, were ineffective in reducing the fungal bioburden. Chlorine dioxide solution was prepared as a control in the same concentration as that generated by tablets; 23 ppm Chlorine dioxide solution was also capable of completely killing A. fumigatus inoculum within 5 minutes.

The tablet solution of Example 21 generated sufficient chlorine dioxide to completely kill the inoculum. The independent components of the tablet, i.e., OXONE & sodium chlorite solutions separately, were not capable of reducing the bioburden, whereas the result of their reaction in solution is strongly fungicidal versus A. fumigatus.

The resulting data is in Table 10.

TABLE 10

| | Surviving bioburden counts (germinating spores - conidia/mL), | | | | | | |
|---|---|---|---|---|---|---|---|
| | 1 × 10⁶ conidia/mL inoculum in reaction mix, 2 replicates average | | | | | | |
| | Water | Buffer | Example 21 | | | Chlorine | |
| Time | pH 6.28 | pH4.4 | 2 Tabs 3.8 L | Oxone | Chlorite | Dioxide | CLOROX |
| 5 min | 5.60E+05 | not tested | 0.00E+00 | 3.45E+05 | 4.25E+05 | 0.00E+00 | 0.00E+00 |
| stdevp* | 1.00E+04 | not tested | 0.00E+00 | 7.25E+04 | 1.43E+05 | 0.00E+00 | 0.00E+00 |
| 15 min | 6.25E+05 | 6.00E+05 | 0.00E+00 | 5.70E+05 | 6.25E+05 | 0.00E+00 | not tested |
| stdevp* | 6.50E+04 | 1.13E+05 | 0.00E+00 | 7.50E+04 | 5.25E+04 | 0.00E+00 | not tested |

Surviving bioburden counts, 2 replicates
average, 1 × 10³ conidia/mL inoculum in
reaction

| | Water | Example 21 |
|---|---|---|
| Time | pH 6.28 | 2 Tabs/3.8 L |
| 15 min | 6.70E+03 | 0.00E+00 |
| stdevp* | 6.25E+02 | 0.00E+00 |

Inoculum verification conidia/mL, 1 replicate

| | 1 × 10⁵ | 1 × 10³ |
|---|---|---|
| Time | Inoculum | Inoculum |
| 5 min | 2.57E+05 | 3.77E+03 |

*Standard deviation

### EXAMPLE 22 AND COMPARATIVE EXAMPLES G-I

Malodor solutions as listed in Table 11 were prepared. Table 11 lists the chemical or mixture used, with the odors represented by each listed beneath. Some of the odors were prepared in an ethanol (EtOH) base because they were insoluble in water. EtOH did not impart a perceptible odor of its own was quite volatile, so in the time it took for water-based odors to dry, EtOH had dried as well. Tablets of the present invention (Example 22) were prepared as previously described using the formulation of Example 7. The tablets were made on the Carver Laboratory Press using a 28 mm die at 10000 psi (69.0×10⁶Pa). Comparative Example F (1000 ppm OXONE) and Comparative Example G (2000 ppm OXONE) were powders. Each was dissolved in 3.8 L of deionized water. Comparative Examples H (50 ppm ClO₂) and Comparative Example I (10 ppm ClO₂) were commercially available products which delivered 5 ppm of ClO₂ per tablet in 3.8 L of water. Sufficient tablets were dissolved in deionized water to obtain the desired level of ClO₂.

TABLE 11

| Cat | | | | | | | |
|---|---|---|---|---|---|---|---|
| Urine | | | | | | | |
| Neat | | | Diethyl | Methyl | Tobacco | 1,2 | Butanoic |
| sample | Mixed | NH₃OH | amine | thiobutyrate | Cigarette | cyclohexadione | acid |
| from | Odor* | 1% in | 250 ppm | 250 ppm in | Smoke in box | 250 ppm in | 250 ppm in |
| veterinarian | In EtOH | H₂O | in EtOH | EtOH | for 10 minutes | EtOH | EtOH |
| | | Ammonia | Fishy | Sour milk | | Stale | Sickening |
| | | | | | | smoke | |
| | | | Urine | Sickening | | Burnt/ | Rancid |
| | | | | | | smoky | |
| | | | Cadaver | Cadaver | | Burnt | Foul/decayed |
| | | | | | | paper | |
| | | | | Fecal | | | Sweaty |
| | | | | Foul/decayed | | | Fecal |
| | | | | Rancid | | | Animal |

| | |
|---|---|
| *butanoic acid | 75 ppm |
| 1,2 cyclohexadione | 75 ppm |
| Methyl thiobutyrate | 75 ppm |
| Diethyl amine | 75 ppm |

Testing was conducted on 4 inch×4 inch (10 cm by 10 cm) carpet swatches. 160 carpet swatches were cut to perform this test. That 15 allowed for each of 8 malodors to be treated on 20 swatches: 5 controls (no further treatment) and 15 tests (3 swatches treated with 5 test deodorizers). The carpet swatches were treated with 5 mL (sprayed) of the malodor solutions as listed in Table 11. For 8 malodors, 20 carpets were sprayed with 5 grams each of that malodor. A standard trigger sprayer was used to apply the malodor to each swatch. All carpets were allowed to dry for 10 minutes so that the water and ethanol bases evaporated.

The test carpets then received treatment of 15 mls of the deodorizer formulations (Example 22 and Comparative Examples F through I) applied via a standard trigger sprayer. The control and test swatches for each malodor were placed in 2 quart plastic storage containers measuring about 20 cm×20 cm×15 cm and sealed. A hinged flap of about 1 cm×1 cm was cut into the top of the container to allow for panelists to smell the headspace inside, then close the flap. In order to evaluate the efficacy of the test deodorizers, 20 panelists rated the treated swatches using a rating scale of 0 to 100 with 0 being no odor and 100 being full order. Results for each odor and each treatment were averaged and summarized below in Table 12.

TABLE 12

| | Cat | Butanoic | | Diethyl | Methyl | | 1,2 | Mixed |
|---|---|---|---|---|---|---|---|---|
| Ex. | Urine | Acid | NH₃OH | amine | thiobutyrate | Tobacco | cyclohexadione | Odor |
| F | 34 | 81 | 30 | 33 | 56 | 87 | 22 | 66 |
| G | 29 | 73 | 21 | 32 | 58 | 72 | 25 | 46 |
| H | 73 | 31 | 69 | 67 | 44 | 34 | 48 | 53 |
| I | 77 | 45 | 73 | 78 | 51 | 41 | 57 | 71 |
| 22 | 39 | 41 | 28 | 31 | 47 | 47 | 17 | 32 |

What is claimed is:

1. A composition comprising an active oxygen compound and precursors for chlorine dioxide in the form of a solid, said solid when weighing a total of about 5 grams dissolves in about 3.8 liters of water at 25° C. in less than 30 minutes, thereby generating a solution containing at least 10 ppm chlorine dioxide.

2. The composition of claim 1 which comprises, by weight,
a) from about 60% to about 90% of a sulfur-containing oxyacid,
b) from about 3% to about 25% of a soluble chlorite salt,
c) from about 3% to about 12% of an alkali metal halide salt or alkaline earth metal halide salt, provided that a cation of said alkali metal salt or alkaline earth halide salt does not form a sulfate with a solubility of less than 1% in 25° C. water, and
d) from about 2% to about 20% of an alkali metal carbonate, alkaline earth metal carbonate, alkali metal bicarbonate, or alkaline earth metal bicarbonate, provided that a cation of said alkali metal carbonate, alkali metal bicarbonate, alkaline earth metal carbonate, or alkaline earth metal bicarbonate does not form a sulfate with a solubility less than 1% in 25° C. water.

3. The composition of claim 2 wherein the sulfur-containing oxyacid contains potassium monopersulfate or dipersulfate, or a mixture thereof.

4. The composition of claim 3 which contains the triple salt of potassium monopersulfate, potassium hydrogen sulfate and potassium sulfate

5. The composition of claim 2 wherein the soluble chlorite salt is sodium chlorite.

6. The composition of claim 2 wherein the alkali metal halide salt or alkaline earth metal halide salt is selected from the group consisting of magnesium chloride, zinc chloride, zinc bromide and sodium chloride.

7. The composition of claim 2 wherein the alkali metal carbonate, alkali metal bicarbonate, alkaline earth metal carbonate or alkaline earth metal bicarbonate is sodium bicarbonate.

8. The composition of claim 2 wherein the composition further comprises from about 0.1% to about 5% by weight of a sugar alcohol, from about 0.1 to about 5% of a carbohydrate, from about 0.1% to about 5% by weight of polyethylene glycol, from about 0.1% to about 5% by weight sodium benzoate, from about 0.1% to about 5% by weight of a fragrance enhancer, or from about 0.1% to about 32% of a filler.

9. The composition of claim 1 in the form of a tablet.

10. The composition of claim 1 in aqueous solution which is an antimicrobial agent.

11. The composition of claim 1 in aqueous solution which is a sanitizing agent or a disinfecting agent.

12. The composition of claim 1 in aqueous solution which is a deodorizing agent.

13. The composition of claim 10 which is a bacteriocidal agent.

14. The composition of claim 10 which is a fungicidal agent.

15. A method of deodorizing surfaces comprising application to the surface of a solution containing the dissolved composition of claim 1.

16. The method of claim 15 comprising application to the surface of a solution of the composition comprising by weight
a) from about 60% to about 90% of a sulfur-containing oxyacid,
b) from about 3% to about 25% of a soluble chlorite salt,
c) from about 3% to about 12% of an alkali metal halide salt or alkaline earth metal halide salt, provided that a cation of said alkali metal salt or alkaline earth halide salt does not form a sulfate with a solubility of less than 1% in 25° C. water, and
d) from about 2% to about 20% of an alkali metal carbonate, alkaline earth metal carbonate, alkali metal bicarbonate, or alkaline earth metal bicarbonate, provided that a cation of said alkali metal carbonate, alkali metal bicarbonate, alkaline earth metal carbonate, or alkaline earth metal bicarbonate does not form a sulfate with a solubility less than 1% in 25° C. water.

17. The method of claim 15 wherein the surface comprises a fibrous substrate.

18. The method of claim 17 where the substrate is a textile or carpet.

19. The method of claim 15 wherein the surface comprises porous concrete, brick, tile, stone, grout, mortar, terrazzo, gypsum board, wood, metal, vinyl, porcelain, granite, laminated materials or composite materials.

20. A method of sanitizing or disinfecting surfaces comprising application to the surface of a solution containing the dissolved composition of claim 1.

21. The method of claim 20 comprising application to the surface of a solution of the composition comprising by weight
a) from about 60% to about 90% of a sulfur-containing oxyacid,
b) from about 3% to about 25% of a soluble chlorite salt,
c) from about 3% to about 12% of an alkali metal halide salt or alkaline earth metal halide salt, provided that a cation of said alkali metal salt or alkaline earth halide salt does not form a sulfate with a solubility of less than 1% in 25° C. water, and
d) from about 2% to about 20% of an alkali metal carbonate, alkaline earth metal carbonate, alkali metal bicarbonate, or alkaline earth metal bicarbonate, provided that a cation of said alkali metal carbonate, alkali metal bicarbonate, alkaline earth metal carbonate, or alkaline earth metal bicarbonate does not form a sulfate with a solubility less than 1% in 25° C. water.

22. The method of claim 20 wherein the surface comprises a fibrous substrate.

23. The method of claim 20 wherein the substrate is a textile or carpet.

24. The method of claim 20 wherein the surfaces comprise porous concrete, brick, tile, stone, grout, mortar, terrazzo, gypsum board, wood, metal, vinyl, porcelain, granite, laminated materials or composite materials.
